(19) United States
(12) Patent Application Publication
(10) Pub. No.: US 2014/0134388 A1
(43) Pub. Date: May 15, 2014

(54) CROSSLINKABLE COPOLYMERS COMPRISING FLUOROVINYLETHER FUNCTIONALIZED AROMATIC MOIETIES

(71) Applicant: E I DU PONT DE NEMOURS AND COMPANY, Wilmington, DE (US)

(72) Inventors: Owen C. Compton, Wilmington, DE (US); Neville Everton Drysdale, Newark, DE (US); Fredrik Nederberg, Greenville, DE (US); Sonjoo Son, Wilmington, DE (US); Judith Johanna Van Gorp, Maastricht (NL)

(73) Assignee: E I Du Pont De Nemours and Company, Wilmington, DE (US)

(21) Appl. No.: 13/677,562

(22) Filed: Nov. 15, 2012

(51) Int. Cl. C08G 63/91; B32B 27/02

(52) U.S. Cl. CPC C08G 63/918; B32B 27/02
USPC 428/97; 525/444

(57) ABSTRACT

Disclosed are copolymers comprising a backbone with olefinic unsaturation and fluorovinylether functionalized aromatic repeat units, and methods to make the copolymers. The copolymers are useful for imparting improved soil, water, and oil resistance to materials including fibers, fabrics, carpets, films, plaques, and shaped articles. The copolymers can be crosslinked and used to form shaped articles with the improved properties.

### FIELD OF THE INVENTION

The invention is related to copolymers comprising fluorovinylether functionalized aromatic repeat units that can be crosslinked. Specifically, the copolymers contain repeat units having an olefinic unsaturated backbone, where the unsaturated double bonds can be crosslinked.

### BACKGROUND

Fluorinated materials have many uses. In particular, they are used in polymer-related industries, and, more particularly, in fiber-related industries, to impart soil, water and oil resistance. Generally, these materials are applied as a topical treatment, but their effectiveness decreases over time due to material loss via wear and washing.

Disclosed in US20110218353 are fluorovinylether functionalized aromatic diesters that may be monomers and comonomers in polyesters, polyamides, and polyoxadiazoles.

There is a need to provide polymeric materials that have improved soil, water, and oil resistance.

### SUMMARY OF THE INVENTION

In one aspect, the invention provides a copolymer comprising a first repeat unit having a backbone and a second repeat unit, wherein said first repeat unit comprises olefinic unsaturation in the backbone thereof, and said second repeat unit is a fluorovinylether functionalized aromatic repeat unit represented by the structure (I)

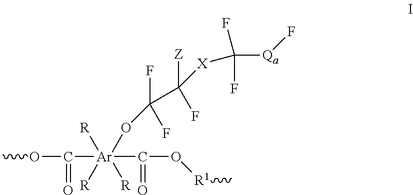

wherein,
Ar represents a benzene or naphthalene radical;
each R is independently H, C₁-C₁₀ alkyl, C₅-C₁₅ aryl, C₆-C₂₀ arylalkyl; OH,
or a radical represented by the structure (II)

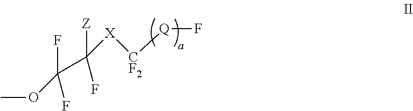

with the proviso that only one R can be OH or the radical represented by the structure (II);
R1 is a C2-C4 alkylene radical which can be branched or unbranched,

### X is O or CF₂;

### Z is H, Cl, or Br;

a=0 or 1;
and,
Q represents the structure (Ia)

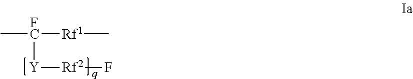

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

In one aspect the first repeat unit having olefinic unsaturation in the backbone thereof is represented by the structure (V)

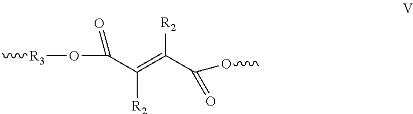

wherein R₂ is independently H or C₁-C₁₀ alkyl;
and R₃ is a C₂-C₄ alkylene radical.

In another aspect, the present invention provides a process comprising combining a fluorovinyl ether functionalized aromatic diester or diacid, an olefinically unsaturated mono-anhydride, and at least one C₂-C₄ alkylene glycol, branched or unbranched, to form a reaction mixture, and stirring the reaction mixture to form a copolymer comprising repeat units having the structure (I)

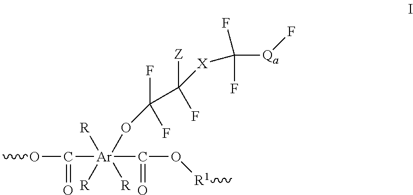

wherein,
Ar represents a benzene or naphthalene radical;
each R is independently H, C₁-C₁₀ alkyl, C₅-C₁₅ aryl, C₆-C₂₀ arylalkyl; OH,
or a radical represented by the structure (II)

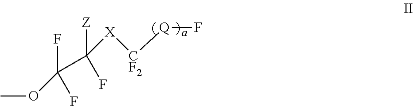

with the proviso that only one R can be OH or the radical represented by the structure (II);
R1 is a C2-C4 alkylene radical which can be branched or unbranched,

### X is O or CF₂;

### Z is H, Cl, or Br;

a=0 or 1;
and,
Q represents the structure (Ia)

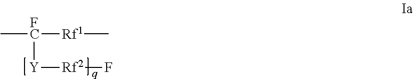

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.
   and repeat units having the structure (V)

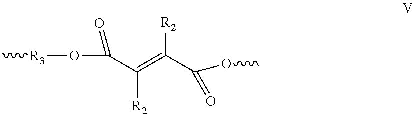

wherein R₂ is independently H or C₁-C₁₀ alkyl;
and R₃ is a C₂-C₄ alkylene radical; and
wherein the fluorovinyl ether functionalized aromatic diester or diacid is represented by the structure (III)

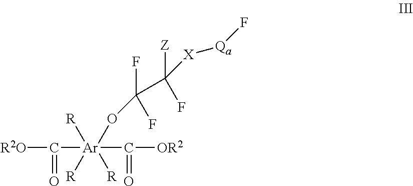

wherein,
Ar represents a benzene or naphthalene radical;
each R is independently H, C₁-C₁₀ alkyl, C₅-C₁₅ aryl, C₆-C₂₀ arylalkyl; OH,
or a radical represented by the structure (II)

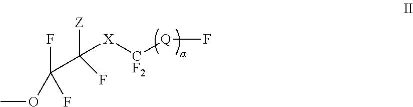

with the proviso that only one R can be OH or the radical represented by the structure (II);
R² is H or C₁-C₁₀ alkyl;

### X is O or CF₂;

### Z is H, Cl, or Br;

a=0 or 1;
and,
Q represents the structure (Ia)

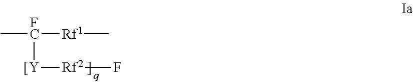

wherein q=0-10;

### Y is O or CF₂;

Rf¹ is (CF₂)ₙ, wherein n is 0-10;
and,
Rf² is (CF₂)ₚ, wherein p is 0-10, with the proviso that when p is 0, Y is CF₂.

In another aspect, the present invention provides a fiber, fabric, carpet, film, plaque, or shaped article comprising the present copolymer.

In another aspect, the present invention provides a resin composition comprising the present copolymer.

In another aspect, the present invention provides a fiber, fabric, carpet, film, plaque, or shaped article impregnated or coated with a resin comprising the present copolymer.

### DETAILED DESCRIPTION

When a range of values is provided herein, it is intended to encompass the end-points of the range unless specifically stated otherwise. Numerical values used herein have the precision of the number of significant figures provided, following the standard protocol in chemistry for significant figures as outlined in ASTM E29-08 Section 6. For example, the number 40 encompasses a range from 35.0 to 44.9, whereas the number 40.0 encompasses a range from 39.50 to 40.49.

The following definitions and abbreviations are to be used for the interpretation of the claims and the specification.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The parameters n, p, and q as employed herein are each independently integers in the range of 1-10.

As used herein, the term “fluorovinyl ether functionalized aromatic diester” refers to that subclass of compounds of structure (III) wherein R² is C₁-C₁₀ alkyl. The term “fluorovinyl ether functionalized aromatic diacid” refers to that subclass of compounds of structure (III) wherein R² is H.

As used herein, the term “copolymer” refers to a polymer comprising two or more chemically distinct repeat units, including dipolymers, terpolymers, tetrapolymers and the like. The term “homopolymer” refers to a polymer consisting of a plurality of repeat units that are chemically indistinguishable from one another.

In any chemical structure herein, when a terminal bond is shown as “—”, where no terminal chemical group is indicated, the terminal bond “—” indicates a radical. For example, —CH₃ represents a methyl radical.

As used herein, the term “resin” refers to a composition containing any thermoplastic or thermoset polymer that can be impregnated in a matrix. A thermoplastic polymer is pliable at temperatures above its glass transition temperature and hardens at room temperature. This process is reversible. A thermoset is pliable prior to exposure to elevated temperature, where it will harden and remain hard upon cooling to room temperature. This curing process is irreversible. In addition, a resin may be hardened with a treatment such as crosslinking, where the addition of a crosslinking agent serves to form covalent bonds between chains during the curing process.

In one aspect, the present invention provides a copolymer comprising a first repeat unit having a backbone and a second repeat unit, wherein said first repeat unit comprises olefinic unsaturation in the backbone thereof, and said second repeat unit is a fluorovinyl ether functionalized aromatic repeat unit represented by the structure (I).

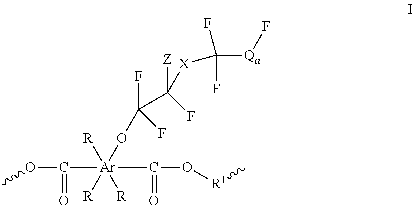

wherein,
Ar represents a benzene or naphthalene radical;
each R is independently H, C₁-C₁₀ alkyl, C₅-C₁₅ aryl, C₆-C₂₀ arylalkyl; OH,
or a radical represented by the structure (II)

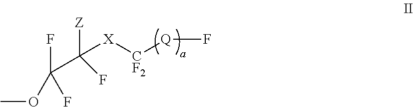

with the proviso that only one R can be OH or the radical represented by the structure (II);
R¹ is a C2-C4 alkylene radical which can be branched or unbranched,

### X is O or CF₂;

### Z is H, Cl, or Br;

a=0 or 1;
and,
Q represents the structure (Ia)

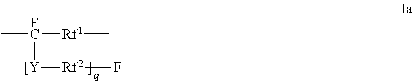

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

As can be noted in the formulas above that show substituents attached to aromatic rings “Ar”, the substituents can be attached to the aromatic rings at any point, thus making it possible to have ortho-, meta- and para-substituents as defined above.

In one embodiment of the polymer, one R is OH.

In one embodiment of the polymer, each R is H.

In one embodiment of the polymer, one R is OH and the remaining two Rs are each H.

In one embodiment of the polymer, one R is represented by the structure (II) and the remaining two Rs are each H.

In one embodiment of the polymer, R¹ is an ethylene radical.

In one embodiment of the polymer, R¹ is a trimethylene radical, which can be branched.

In one embodiment of the polymer, R¹ is a tetramethylene radical, which can be branched.

In one embodiment of the polymer, X is O. In an alternative embodiment, X is CF₂.

In one embodiment of the polymer, Y is O. In an alternative embodiment, Y is CF₂.

In one embodiment of the polymer, Z is Cl or Br. In a further embodiment, Z is Cl. In an alternative embodiment, one R is represented by the structure (II), and one Z is H. In a further embodiment, one R is represented by the structure (II), one Z is H, and one Z is Cl.

In one embodiment of the polymer, Rf¹ is CF₂.

In one embodiment of the polymer, Rf² is CF₂.

In one embodiment of the polymer, Rf² is a bond (that is, p=0), and Y is CF₂.

In one embodiment, a=0.

In one embodiment, a=1, q=0, and n=0.

In one embodiment of the polymer, each R is H, Z is Cl, R¹ is methoxy, X is O, Y is O, Rf¹ is CF₂, and Rf² is perfluoropropenyl, and q=1.

Structure (I) is embodied by multiple repeat unit structures, any of which may be included alone or in any combination in the present copolymer. The copolymer can thus contain repeat units of structure (I) that are the same or different.

In one embodiment the specific repeat unit represented by structure (I) is represented by the structure (IVa):

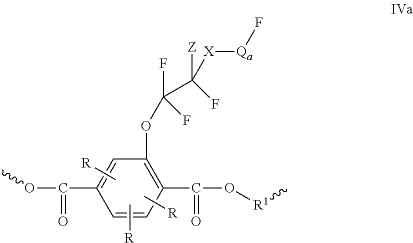

wherein R, R¹, Z, X, Q, and a are as stated supra.

In one embodiment the specific repeat unit represented by structure (I) is represented by the structure (IVb):

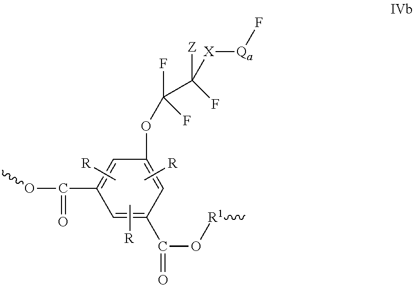

wherein R, R¹, Z, X, Q, and a are as stated supra.

The first repeat unit of the present copolymer comprises olefinic unsaturation in the backbone. The first repeat unit may be represented by the structure (V):

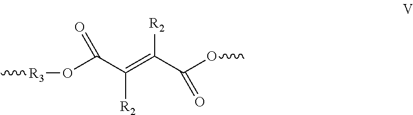

wherein each R₂ is independently H or C₁-C₁₀ alkyl;
and R₃ is a C₂-C₄ alkylene radical.

Structure (V) is embodied by multiple repeat unit structures, any of which may be included alone or in any combination in the present copolymer. The copolymer can thus contain repeat units of structure (V) that are the same or different.

In one embodiment the copolymer further comprises third repeat units of the structure (VI):

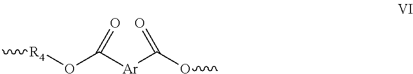

wherein R₄ is a C₂-C₄ alkylene radical, and Ar is an aromatic diradical.

Inclusion of repeat units of structure (VI) in the present copolymer may be desired to alter properties of the copolymer such as increasing strength, stiffness, and hardness.

In one embodiment, the present copolymer is a random copolymer. The order of repeat units is random. The likelihood of the same unit repeating more than once in adjacent position is dictated by the mole fraction of the monomer from which the repeat unit is derived in the reaction mixture used to prepare a copolymer. A repeat unit may be found in from 1 to 25 units in a row, with higher values possible, but unlikely. Thus, due to the random nature of monomer addition to the polymer chain, some repeat units may only occur sparingly, for example the fluorinated monomer, when the monomer from which the repeat unit is derived is very dilute in the reaction mixture.

In one embodiment, the copolymer is a block copolymer.

The present copolymer may be used in making items such as a fiber, fabric, carpet, film, plaque, or shaped article, which may be molded. Various embodiments are a fiber, fabric, carpet, film, plaque, or shaped article comprising the present copolymer. In another embodiment is a resin containing the present copolymer that may be used for impregnating or coating an item such as fiber, fabric, carpet, film, plaque, or shaped article, which may be molded. Thus various embodiments include a fiber, fabric, carpet, film, plaque, or shaped article coated with a resin containing the present copolymer. Typically the resin is applied at elevated temperature where it is pliable, and then hardens at room temperature.

In another aspect, the present invention provides a process comprising combining a fluorovinyl ether functionalized aromatic diester or diacid, an olefinic (unsaturated) mono-anhydride, and at least one C₂-C₄ alkylene glycol, branched or unbranched, to form a reaction mixture, and stirring the reaction mixture to form a copolymer comprising repeat units of structure (I). The reaction mixture may include additional components such as an inhibitor that neutralizes free radicals which retards polymerization. Examples of an inhibitor that may be used include, for example, mono- or di-substituted catechols (e.g., 4-tert-butylcatechol, 3-phenylcatechol, 3,5- or 3,6-dialkylcatechols) and mono- or di-substituted quinones (e.g., toluhydroquinone, 2,5-dialkylhydroquinone).

The fluorovinyl ether functionalized aromatic diester or diacid is represented by the structure (III),

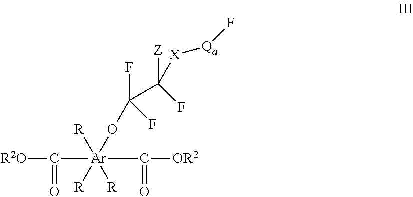

wherein,
Ar represents a benzene or naphthalene radical;
each R is independently H, C₁-C₁₀ alkyl, C₅-C₁₅ aryl, C₆-C₂₀ arylalkyl; OH,
or a radical represented by the structure (II)

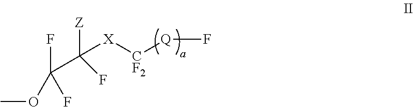

with the proviso that only one R can be OH or the radical represented by the structure (II);
R² is H or C₁-C₁₀ alkyl;

### X is O or CF₂;

### Z is H, Cl, or Br;

a=0 or 1;
and,
Q represents the structure (Ia)

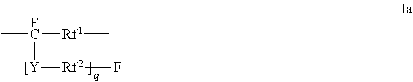

wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂. In some embodiments, the reaction is carried out at about the reflux temperature of the reaction mixture.

In one embodiment of the process, one R is OH.

In one embodiment of the process, each R is H.

In one embodiment of the process, one R is OH and the remaining two Rs are each H.

In one embodiment of the process, one R is represented by the structure (II) and the remaining two Rs are each H.

In one embodiment of the process, R² is H.

In one embodiment of the process, R² is methyl.

In one embodiment of the process, X is O. In an alternative embodiment, X is CF₂.

In one embodiment of the process, Y is O. In an alternative embodiment, Y is CF₂.

In one embodiment of the process Z is Cl or Br. In a further embodiment, Z is Cl. In an alternative embodiment, one R is represented by the structure (II), and one Z is H. In a further embodiment, one R is represented by the structure (II), one Z is H, and one Z is Cl.

In one embodiment of the process, Rf¹ is CF₂.

In one embodiment of the process, Rf² is CF₂.

In one embodiment of the process, Rf² is a bond (that is, p=0), and Y is CF₂.

In one embodiment, a=0.

In one embodiment, a=1, q=0, and n=0.

In one embodiment of the process, each R is H, Z is Cl, R² is methyl, X is O, Y is O, Rf¹ is CF₂, and Rf² is perfluoropropenyl, and q=1.

In one embodiment the fluorovinyl ether functionalized aromatic diester or diacid is represented by the structure (VII):

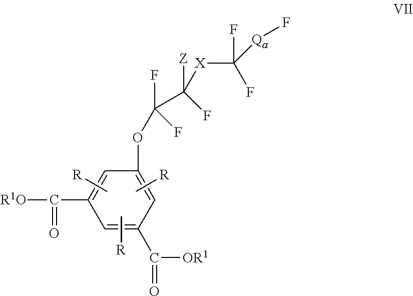

wherein R, R¹, Z, X, Q, a are as stated supra.

Suitable fluorovinyl ether functionalized aromatic diesters can be prepared as disclosed in US20110218353, which is incorporated herein by reference, by forming a reaction mixture comprising a hydroxy aromatic diester in the presence of a solvent and a catalyst with a perfluoro vinyl compound.

The mono-anhydride is represented by the structure (VIII):

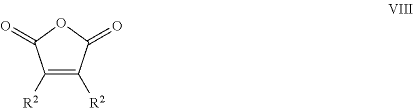

wherein each R² is independently H or C₁-C₁₀ alkyl.

An example of structure (VIII) is maleic anhydride. Upon hydrolysis of maleic anhydride, maleic acid is generated with the two carboxylic acid groups cis to one another. Isomerization into the trans form occurs during polymerization with one or more C₂-C₄ alkylene glycol. This conversion is readily achieved with typically over 90% of the trans isomer present at the end of the reaction. The trans isomer affords the copolymer with enhanced mechanical integrity.

At least one C₂-C₄ alkylene glycol that is either branched or unbranched is included in the reaction producing the present copolymer. Suitable alkylene glycols include, but are not limited to, 1,2-ethanediol, 1,2-propylene glycol, 1,3-propanediol, 1,2-butanediol, 1,3-butanediol, 1,4-butanediol, diethylene glycol, dipropyleneglycol, neopentyl glycol, 2-methyl-1,3-propanediol, 2,2-dimethyl-1,3-propanediol, and mixtures of two or more thereof. In one embodiment, the alkylene glycol is a combination of 1,3-propanediol and 1,2-propylene glycol.

In addition, in the present process the combined reagents in the reaction mixture may further comprise an aromatic anhydride represented by the structure (IX):

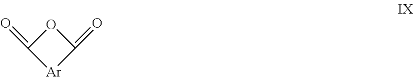

wherein Ar is an aromatic radical, such as a benzene radical. Suitable examples of structure IX include, but are not limited to, phthalic anhydride (PA), hexahydrophthalic acid, tetrachlorophthalic anhydride, and tetrabromophthalic anhydride. The halogenated compounds may be included to provide flame resistance.

In one embodiment to increase strength, stiffness, and hardness of the copolymer, PA is included in between about 50 mole % and 75 mole % in the reaction mixture.

In one embodiment the reaction is carried out in the melt. The thus resulting polymer can be separated by vacuum distillation to remove the excess of C₂-C₄ glycol.

In one embodiment the reaction mixture comprises more than one embodiment of the repeat units encompassed in structure (I).

In another embodiment the reaction mixture comprises more than one embodiment of the repeat units encompassed in structure (V).

In another embodiment the reaction mixture comprises more than one embodiment of the repeat units encompassed in structure (VI).

In one embodiment, when the following reactants are included, they are added in the order: 1,3-propanediol (1,3-PDO); 1,2-propylene glycol (1,2-PG), phthalic anhydride (PA), fluorovinyl ether functionalized aromatic diester or diacid, hydroquinone (HQ), and maleic anhydride (MA). The reaction can be conducted in the melt, preferably within the temperature range of about 100 to 150° C., to distill off water, after which the mixture can be further heated, preferably to a temperature within the range of about 200 to 250° C., and thereby form a copolymer comprising repeat units having structures (I) and (V).

In one embodiment the present copolymer is chemically crosslinked to form a crosslinked copolymer material. The crosslinked copolymer material has covalently attached chemical links between the unsaturated backbone of first repeat units shown in structure (V). The crosslinks may be formed both intra-molecularly, within one molecule of the copolymer, and inter-molecularly, between different molecules of the copolymer. In the case of intra-chain linkage, the copolymer chain is looped back upon itself. In the case of inter-chain linkage, two copolymer chains are linked to one another. Cross-linkage can occur between multiple chains with one copolymer chain likely being linked to several other chains during crosslinking. Typically both intra- and inter-molecular crosslinks are present in a crosslinked material of the present copolymer.

In one embodiment a method is provided for forming a crosslinked material comprising the present copolymer. Crosslinking agents that may be used to form crosslinks between the unsaturated bonds in the present copolymer include unsubstituted and substituted vinyl aromatics, vinyl esters of carboxylic acids, acrylates, methacrylates, hydroxyalkyl acrylates, hydroxyalkyl methacrylates, acrylamides, methacrylamides, acrylonitrile, methacrylonitrile, alkyl vinyl ethers, allyl esters of aromatic di- and polyacids, and the like, and mixtures thereof. Preferred vinyl monomers are vinyl aromatics, halogenated vinyl aromatics, methacrylic acid esters, and diallyl esters of aromatic di- and polyacids. Particularly preferred vinyl monomers are styrene, vinyl toluene, methyl methacrylate, divinylbenzene and diallyl phthalate. Typically 1,3-propanediol-diacrylate, 1,3-propanediol-dimethacrylate, and/or styrene are used as crosslinking agents.

The present copolymer and at least one crosslinking agent are mixed to form a curable composition. The curable composition may include additional components such as an inhibitor that neutralizes free radicals. Examples of an inhibitor that may be used include, for example, mono- or di-substituted catechols (e.g., 4-tert-butylcatechol, 3-phenylcatechol, 3,5- or 3,6-dialkylcatechols) and mono- or di-substituted quinones (e.g., toluhydroquinone, 2,5-dialkylhydroquinone).

An initiator is added to react the crosslinking agent and copolymer, forming a crosslinking composition. Initiators that may be used include, but are not limited to, AIBN (Azobisisobutyronitrile), ternary initiators including benzoyl peroxide complexes, and organic peroxides such as Luperox® 26. Some crosslinking initiators are used together with a promoter, such as the use of Luperox® 26 with cobalt as a promoter. Initiators are commercially available, for example Luperox® 26 is available from Arkema, Inc., (King of Prussia, Pa.).

Typically the temperature of a crosslinking composition is raised above room temperature to facilitate crosslinking. Multiple temperatures may be used, but this is not necessarily required for curing. Typically during crosslinking the temperature of the curable composition and initiator mixture is slowly increased to support sufficient crosslinking to produce a solid material without being cloudy. For example, the temperature may be increased in stages with periods of time at each stage, or it may be increased continuously and slowly. Stages of temperature increase may include, for example, about 40° C. for about an hour, about 55° C. for about 4 hours, about 80° C. for about 2 hours, and about 120° C. for about one hour.

In one embodiment the present crosslinked copolymer is used in a film, plaque, or shaped article, which may be a molded article of any shape. In one embodiment, a shaped article comprising the present crosslinked copolymer has a curved surface such as in body armor, a helmet, a bowling ball, and the like. In another embodiment is a resin containing the present crosslinked copolymer that may be used for impregnating or coating an item such as fiber, fabric, carpet, film, plaque, or shaped article, which may be molded. Any method may be used for impregnating or coating an item with said resin, such as spraying, dipping, compacting, pressing, rod-coating, saturation coating, and the like. Thus in various embodiments are a fiber, fabric, carpet, film, plaque, or shaped article impregnated or coated with a resin containing the present crosslinked copolymer.

The presence of fluorine in the present copolymer provides soil, water, and oil resistance. Contact angle measurements for both water and hexadecane were shown, in Examples 9 and 10 herein, to be higher for surfaces of plaques made from the present crosslinked copolymer, in comparison to polymers lacking the structure (I) repeat unit containing fluorine.

Of particular value is the finding herein of blooming of fluorine to a surface of a molded article such that the concentration of fluorine on that surface is greater than predicted for an even fluorine concentration throughout the article. The greater than predicted concentration of fluorine on the surface is enhanced surface fluorine. The enhanced surface fluorine allows lower content of fluorine in the copolymer to achieve equivalent soil, oil, and water resistance as compared to a situation without this effect. It was found, as shown in Example 8 herein, that when the present copolymer is crosslinked and molded into a plaque with one side in contact with a poly(tetrafluoro ethylene) surface and the other side in contact with glass, there is a higher fluorine to carbon ratio on the side that was in contact with the poly(tetrafluoro ethylene) surface than on the side that was in contact with glass. Thus despite the entanglement of the copolymer molecules due to crosslinking, fluorines were able to migrate to the surface contacting poly(tetrafluoro ethylene).

Articles may be prepared with the present crosslinked copolymer, which have enhanced surface fluorine on at least one surface. Enhanced surface fluorine is determined by the article having a greater fluorine atom to carbon atom ratio, determined by surface chemical analysis, than the theoretical value of the fluorine atom to carbon atom ratio of the crosslinked copolymer. These articles are prepared by crosslinking and molding the present copolymer in a mold having on at least one surface of contact with the crosslinking composition a material containing a polymer with a fluorinated alkyl chain. The alkyl chain may be fully or partially fluorinated, and may be the sole component of the polymer chain or a part of a copolymer. Thus the material contains a polymer, linear copolymer, or branched copolymer comprising a fully or partially fluorinated alkyl chain. Examples of materials that may be used include, but are not limited to, poly(tetrafluoro ethylene), polyvinylidene fluoride, polychlorotrifluoroethylene, a copolymer of ethylene and chlorotrifluoroethylene, and the sulfonated tetrafluoroethylene-based fluoropolymer Nafion®. More than one side of the crosslinking composition may be in contact with the material containing a polymer with a fluorinated alkyl chain surface during molding. Typically a surface of a mold will be coated, for example, with poly(tetrafluoro ethylene) or lined with a material coated, for example, with poly(tetrafluoro ethylene). Poly(tetrafluoro ethylene) is available commercially as Teflon® and Nafion® is commercially available, both from DuPont (Wilmington, Del.), polyvinylidene fluoride is available commercially as Hylar® and a copolymer of ethylene and chlorotrifluoroethylene is available commercially as Halar® from Solvay International Chemical Group (Brussels, Belgium), polychlorotrifluoroethylene is available commercially as Aclar® from Honeywell Inc.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows: “h” means hour(s), “min” means minute(s), “L” means liter(s), “mL” means milliliter(s), “μL’ means microliter, “g” means grams, “ppm” means parts per million “w/w” means weight/weight, “cSt” means centiStokes. “˜” means approximately, “cm” means centimeter, “m” means meter, “′” means inch.

### General Methods

The Chemicals and Reagents were Used as Received in the Examples as Follows

1,2-Propylene glycol (1,2-PG), phthalic anhydride (PA), maleic anhydride (MA), hydroquinone (HQ), toluhydroquinone, 1,4-naphthoquinone, toluene, methanol, phenolphthalein, 0.1 N KOH in methanol, cobalt(II) 2-ethylhexanoate solution (65 wt %) in mineral spirits, styrene, benzoyl peroxide, tetrahydrofuran, dimethyl 5-hydroxyisophthalate, potassium t-butoxide, hydrochloric acid, dichloromethane, and anhydrous sodium sulfate were obtained from Sigma-Aldrich (St. Louis, Mo.). Luperox® 26 (tert-butyl peroxy-2-ethylhexanoate) was obtained from Arkema, Inc., (King of Prussia, Pa.). 1,3-Propanediol (1,3-PDO) was obtained from DuPont Tate and Lyle BioProducts™ (Loudon, Tennessee). 1,3-Propanediol-diacrylate (1,3-PDO-DA) and 1,3-propanediol-dimethacrylate (1,3-PDO-DMA) were obtained from Monomer Polymer & Dajac Labs, Inc. (Trevose, Pa.). SurfaSil™ Siliconizing Fluid was obtained from Pierce Biotechnology (Rockford, Ill.). PTFE coated fiberglass Duralam® Gold Fabric (25 Series) was purchased from Advanced Flexible Composites (Lake in the Hills, Ill.). 1,1,1,2,2,3,3-heptafluoro-3-(1,1,1,2,3,3-hexafluoro-3-(1,2,2-trifluorovinyloxy)propan-2-yloxy)propane was obtained from SynQuest Labs., Alachua, Fla.

Dimethyl 5-(1,1,2-Trifluoro-2-(1,1,2,3,3,3-hexafluoro-2-perfluoropropoxy) propoxy)ethoxy)isophthalic acid (structure (X)) was prepared as disclosed in US20110218353, as follows.

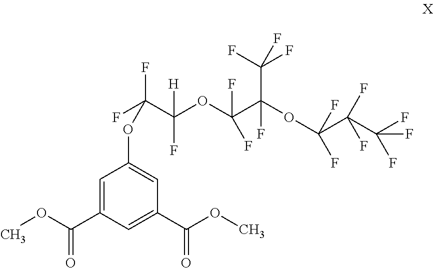 [SMILES: COC(=O)c1cc(OC(F)(F)C(F)OC(F)(F)C(F)(OC(F)(F)C(F)(F)C(F)(F)F)C(F)(F)F)cc(C(=O)OC)c1]

In a dry box, tetrahydrofuran (THF, 1000 mL) and dimethyl 5-hydroxyisophthalate (42.00 g, 0.20 mol) were added to an oven dry round bottom reaction flask equipped with a stirrer and an addition funnel; then potassium t-butoxide (6.16 g, 0.055 mol) was added. 1,1,1,2,2,3,3-Heptafluoro-3-(1,1,1,2,3,3-hexafluoro-3-(1,2,2-trifluorovinyloxy)propan-2-yloxy)propane (216 g, 0.50 mol) was then added via the addition funnel forming a reaction. The reaction was allowed to stir at room temperature. After 24 hours the reaction was terminated via the addition of 80 mL of 10% HCl. The reaction was concentrated at reduced pressure, diluted with dichloromethane, washed with 10% HCl (2×100 mL) and then with water (2×100 mL) forming an organic phase and a crude product. The organic phase was dried over anhydrous sodium sulfate and concentrated at reduced pressure. The crude product was purified by column chromatography to give 86.07 g (67.32%) yield of dimethyl 5-(1,1,2-trifluoro-2-(1,1,2,3,3,3-hexafluoro-2-(perfluoropropoxy)propoxy)ethoxy)isophthalate.

Conversion of dimethyl 5-(1,1,2-trifluoro-2-(1,1,2,3,3,3-hexafluoro-2-(perfluoropropoxy)propoxy)ethoxy)isophthalate to 5-(1,1,2-Trifluoro-2-(1,1,2,3,3,3-hexafluoro-2-perfluoropropoxy)propoxy)ethoxy)isophthalic acid (F16-IPA) was performed as follows. In a round bottom flask equipped with a stirrer and condenser, potassium hydroxide (19.6 g, 0.349 mol) was completely dissolved in water (500 mL). Dimethyl 5-(1,1,2-trifluoro-2-(1,1,2,3,3,3-hexafluoro-2-(perfluoropropoxy)propoxy)ethoxy)isophthalate (22.5 g, 0.035 mol) was then added forming a reaction. The reaction was then heated to reflux and allowed to stir. After 24 hours the reaction was cooled to room temperature and terminated via the addition of concentrated HCl (12 molar) until a pH value of 1 was measured. The product was separated via vacuum filtration and allowed to dry under vacuum overnight to give 21.13 g (98.3%) yield of F16-IPA.

### Acid Number of UP Mixture of Example 1

Acid number (AN) was quantified periodically (every 1.5 h) during heating of the reaction mixture at 215° C. by removing a 15 g aliquot from the reaction mixture. This aliquot was dissolved in a mixture of styrene (10 g) containing 500 ppm of 1,4-naphthoquinone. The 60/40 w/w reaction sample/styrene mixture (8 g) was then mixed with 25 ml of a toluene/methanol mixture (70/30 w/w mixture; 175 g of toluene and 75 g of methanol) containing phenolphthalein (0.025 g, 0.01% by weight). The resulting solution was titrated with 0.1 N KOH in methanol until the phenolphthalein indicator turned pink. AN is the number of milligrams of KOH required to titrate (or neutralize) one gram of the reaction mixture sample, calculated following equation 1:

AN=volume of titrant consumed (mL)×Normality of KOH×(56.1)/mass of UP sample (g) Eq. 1

### Viscosity of UP Mixture of Example 1

Viscosity was monitored following ASTM D1545 using BYK-Gardner bubble viscometer standards (BYK-Gardner, Columbia, Md.). These standards were sealed in lettered glass tubes labeled A5 through Z10 and cover a range of viscosities from 0.05 to 1000 cSt. The Gardner Holdt viscosity of N-Q required for completion of the UP synthesis in Example 1 equates to a viscosity of 345˜442 cSt. Viscosity was evaluated by corking a sample tube containing an aliquot of the 60/40 w/w reaction sample/styrene mixture (˜15 g) described in the AN method. This sample and the viscosity standard tubes were then equilibrated for 10 min in a 25° C. water bath. Comparison of the reaction sample/styrene mixture aliquot and viscosity standard was achieved by inserting both into a holder, turning the holder over, and monitoring the rise time of the bubble in the sample. The Gardner Holdt viscosity of the reaction sample/styrene mixture aliquot was determined qualitatively by choosing the letter of the standard whose bubble rise time best matched that of the reaction sample/styrene mixture aliquot.

### Mold Fabrication

A mold was fabricated for casting the curable compositions prepared in Examples. The plate faces of two 12″×12″ (30.48 cm×30.48 cm) tempered glass plates (¼″ thick (0.635 cm) were coated with a thin layer of silicone mold release agent (SurfaSil™ siliconizing fluid), applied in a circular motion with a soft cloth. A layer of Duralam® Gold Fabric possessing a poly(tetrafluoro ethylene) surface was placed on the inward-facing surface of one tempered glass plate to facilitate plaque release. The glass plates were then separated by rectangular Teflon® spacers (1″×⅛″ (2.54 cm×0.32 cm)). Latex tubing (diameter=⅛ (0.32 cm), wall thickness= 1/16″ (0.06 cm)) was formed into a U-shaped gasket between the tempered glass panes and was secured within the mold with binder clips. The mold produces a ⅛″ inch (0.32 cm) thick plaque.

### Plaque Surface Preparation

The surface of a molded plaque was cleaned using circular motions with a soft cloth wetted with acetone.

### Example 1

Unsaturated Polyester Synthesis

A fluorinated unsaturated polyester (F16-UP) was synthesized in a 1 L, 4-neck round bottom flask equipped with a heating mantle, overhead mechanical stirrer, nitrogen sparge, Schnyder column distillation apparatus (with a 100 mL round bottom receiving flask), and an overhead thermometer. The flask was filled with nitrogen gas from the sparge prior to the addition of, in this order, 1,3-PDO (91.2 g), 1,2-PG (22.8 g), PA (122.6 g), F16-IPA (17.5 g), HQ (0.0252 g), and MA (56.0 g). The temperature of the mixture was first raised to 120° C. at a rate of 6° C./min and held at that temperature for 30 min. with water being continually distilled off during that period. The temperature of the mixture was then raised to 215° C. at a rate of 6° C./min, with continued water distillation. Reaction progress during heating at 215° C. was followed by determining the acid number (AN, see General Methods) and Gardner Holdt viscosity level (see General Methods) of the mixture at regular intervals (every 1.5 h). The reaction was discontinued when the AN reached a level of 12 and the Gardner Holdt viscosity reached a level of O—P (378-409 cSt). The reaction temperature was then lowered from 215° C. to 140° C. by blowing air from a plastic hose over the resulting F16-UP product while stirring. The total mass of the product after completion was 238.3 g, from which aliquots were taken to serve as the starting material for Examples 2-4. A ¹H-NMR spectrum of the Example 1 product was collected, which contained signals as indicated for each reactant: 1) PA—δ 7.53 (s), δ 7.73 (s); 2) MA—δ 6.23 (d, cis), δ 6.86 (dd, trans); 3) F16-IPA—δ 6.11 (s), δ 8.03 (m), 88.59 (m). The structures of the reactants and a portion of a resulting random copolymer product are shown in Scheme 1, with M given as 3 alternative structures.

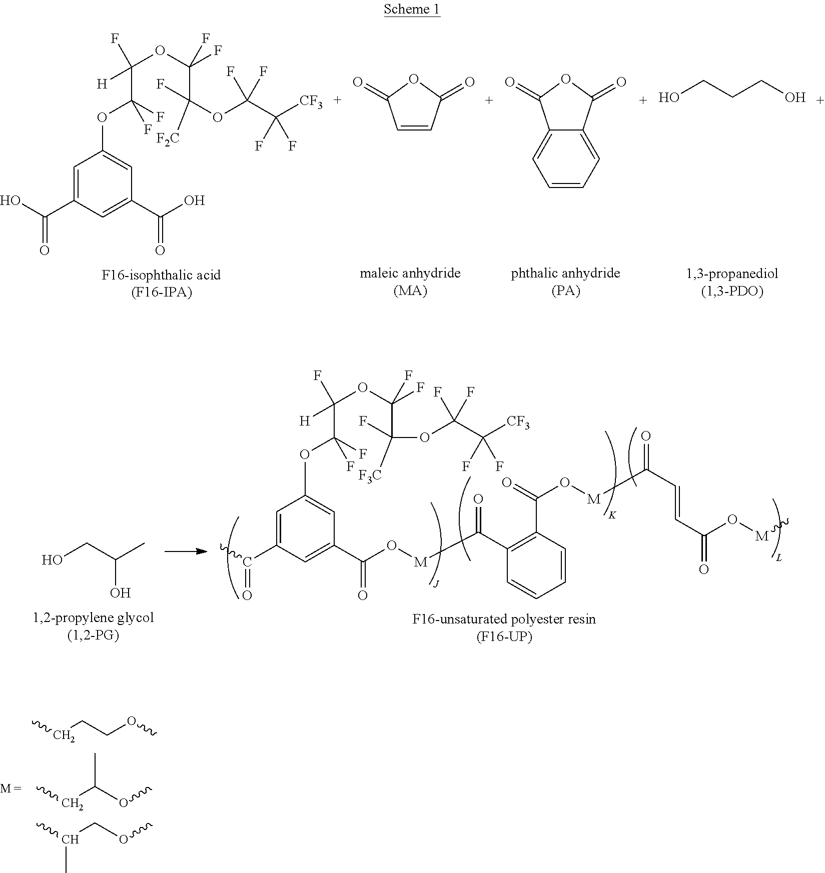

where the J, K, and L segments are in any order, and J, K, and L are independently any integer between 1 and about 25.

### Example 2

### Generating a Curable Composition by 1,3-PDO-DA Addition

An aliquot of the F16-UP product generated in Example 1 (60 g) was placed in a round bottom flask and stirred at 120° C. An aliquot of 1,3-PDO-DA (40 g) was then added and the mixture was stirred until a homogeneous solution was obtained. The resulting curable composition was then cooled to room temperature and used in the casting of the plaque described in Example 5 (vide infra).

### Example 3

### Generating a Curable Composition by 1,3-PDO-DMA Addition

An aliquot of the F16-UP product generated in Example 1 (37.40 g) was placed in a round bottom flask and stirred at 120° C. An aliquot of 1,3-PDO-DMA (20.14 g) was then added and the mixture was stirred until a homogeneous solution was obtained. The resulting curable composition was then cooled to room temperature and used in the casting of the plaque described in Example 6 (vide infra).

### Example 4

### Generating a Curable Composition by Styrene and 1,3-PDO-DMA Addition

An aliquot of the F16-UP product generated in Example 1 (50 g) was placed in a round bottom flask and aliquots of 1,3-PDO-DMA (13.46 g) and styrene (13.46 g) were then added with stirring. The resulting curable composition was used in the casting of the plaque described in Example 7 (vide infra).

### Example 5

### Casting a Plaque of Curable Composition Generated in Example 2

An aliquot of the curable composition prepared in Example 2 (100 g) was mixed in a 1 L beaker with 0.03 g of cobalt(II) 2-ethylhexanoate solution (0.0195 g of cobalt (II) 2-ethylhexanoate and 0.0105 g of mineral spirits) until homogeneity was reached. Then a mixture of 1.2 g of Luperox® 26 and 1.2 g of 1,3-PDO-DA was stirred into the curable composition mixture until homogeneity was reached. This solution was then placed into a vacuum oven set to room temperature with active vacuum for 20 min. The solution was then slowly poured from the beaker into a mold prepared as described in General Methods through the U-shaped gasket, formed by the latex tubing in the assembled mold, to mitigate the formation of air bubbles. The mold was then placed in a convection oven set to 40° C. for 1 h. The temperature was then raised to 54° C. for 3 h then further raised to 82° C. for 2 h. After this initial curing cycle, the binder clips, Teflon® spacers, and latex hose were removed from the mold. The formed plaque and remaining mold configuration were then placed in a convection oven set to 121° C. for 1 h. The plaque and remaining mold configuration were then placed in a water bath to cool. The resulting plaque contains the F16-UP copolymer with 1.3-PDO-DA cross-links in the maleic-anhydride portion of the copolymer chain as shown in Scheme 2.

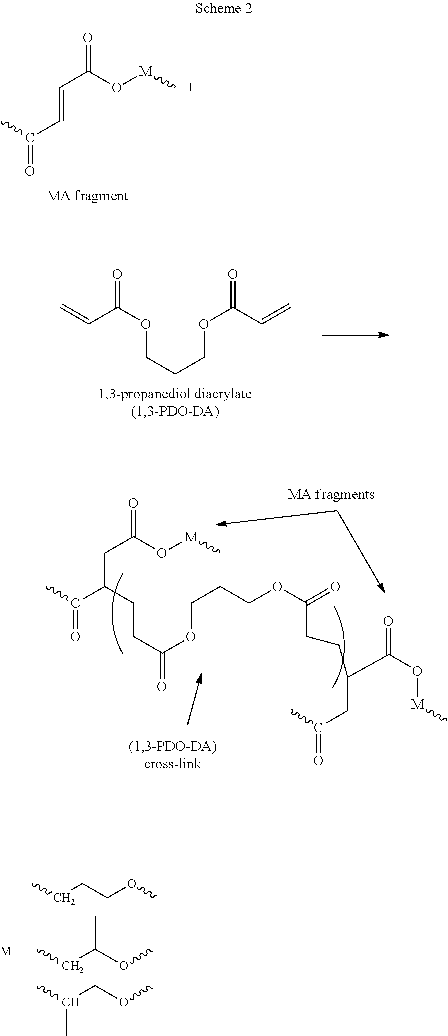

### Example 6

### Casting a Plaque of Curable Composition Generated in Example 3

An aliquot of the curable composition prepared in Example 3 (57.54 g) was mixed in a 1 L beaker with 0.019 g of a cobalt(II) 2-ethylhexanoate solution (0.0124 g of cobalt (II) 2-ethylhexanoate and 0.0066 g of mineral spirits) until homogeneity was reached. Then a mixture of 0.7 g of Luperox® 26 and 0.7 g of 1,3-PDO-DA was stirred into the curable 1.0 composition mixture until homogeneity was reached. This solution was then placed into a vacuum oven set to room temperature with active vacuum for 20 min. The solution was then slowly poured from the beaker into a mold prepared as described in General Methods through the opening of the U-shaped gasket, formed by the latex tubing in the assembled mold, to mitigate the formation of air bubbles. The mold was then placed in a convection oven set to 44° C. for 1 h. The temperature was then raised to 47° C. for 1 h and then further raised to 54° C. for 3 h. After this initial curing cycle, the binder clips, Teflon® spacers, and latex hose were removed from the mold. The formed plaque and remaining mold configuration were then placed in a convection oven set to 82° C. for 2 h. The plaque and remaining mold configuration were then placed in a water bath to cool. The resulting plaque contains the F16-UP copolymer with 1,3-PDO-DMA cross-links in the maleic-anhydride portion of the copolymer chain as shown in Scheme 3.

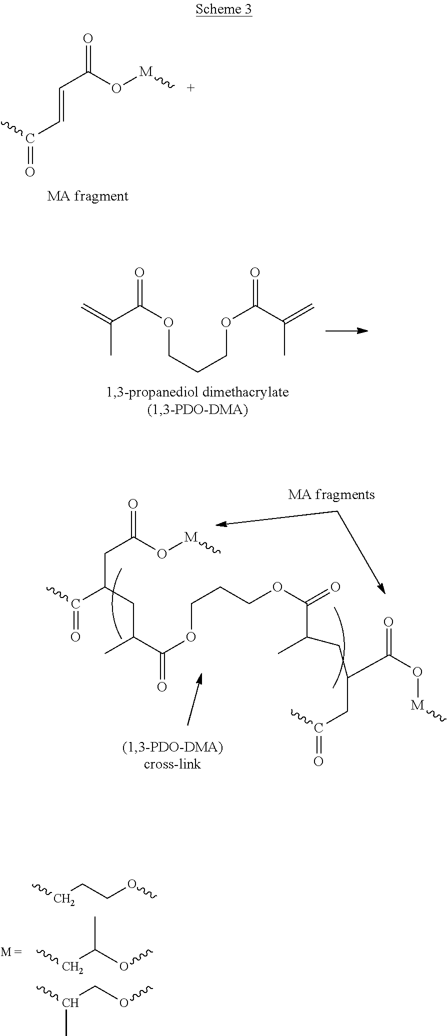

### Example 7

### Casting a Plaque of Curable Composition Generated in Example 4

An aliquot of the curable composition prepared in Example 4 (76.92 g) was mixed in a 1 L beaker with 0.025 g of a cobalt(II) 2-ethylhexanoate solution (0.0163 g of cobalt (II) 2-ethylhexanoate and 0.0087 g of mineral spirits) until homogeneity was reached. Then a mixture of 0.9 g of Luperox® 26 and 0.9 g of 1,3-PDO-DA was stirred into the curable 1.0 composition mixture until homogeneity was reached. This solution was then placed into a vacuum oven set to room temperature with active vacuum for 20 min. The solution was then slowly poured from the beaker into mold through the opening of the U-shaped gasket, formed by the latex tubing in the assembled a mold prepared as described in General Methods, to mitigate the formation of air bubbles. The mold was then placed in a convection oven set to 40° C. for 1 h. The temperature was then raised to 47° C. for 1 h and raised further to 54° C. for 3 h. After this initial curing cycle, the binder clips, Teflon® spacers, and latex hose were removed from the mold. The formed plaque and remaining mold configuration were then placed in a convection oven set to 82° C. for 1 h. The plaque and remaining mold configuration were then placed in a water bath to cool. The resulting plaque contains the F16-UP copolymer with 1.3-PDO-DMA cross-links and styrene cross-links in the maleic-anhydride portion of the copolymer chain as shown in Scheme 4.

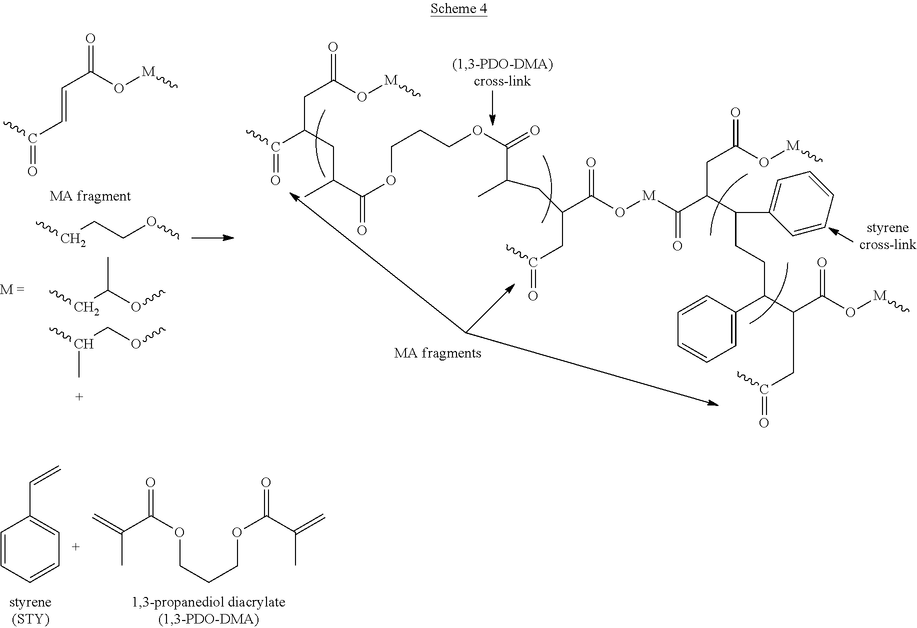

### Comparative Example A

An unsaturated polyester (UP-A) was synthesized in a 5 L, 4-neck round bottom flask equipped with a heating mantle, overhead mechanical stirrer, nitrogen sparge, Schnyder column distillation apparatus (with a 500 mL round bottom receiving flask), and an overhead thermometer. The flask was filled with nitrogen gas from the sparge prior to the addition of, in this specific order, 1,3-PDO (798.20 g), PA (888.37 g), HQ (0.1825 g), and MA (392.00 g). The temperature of the mixture was first raised to 120° C. at a rate of 2° C./min and held for 2 h with water being continually distilled off. The temperature of the mixture was then raised to 215° C. at a rate of 6° C./min with continued water distillation. Reaction progress during heating at 215° C. was followed by determining the acid number (AN, see General Methods) and Gardner Holdt viscosity level (see General Methods) of the mixture at regular intervals (every 1.5 h). The reaction was discontinued when the AN reached a level of 11 and the Gardner Holdt viscosity reached a level of O—P. The reaction temperature was then lowered from 215° C. to 145° C. by blowing air from a plastic hose over the resulting UP-A mixture while stirring. The total mass of the mixture after completion was 1836.4 g. The structures of the reactants and a portion of a resulting random copolymer product are shown in Scheme 5.

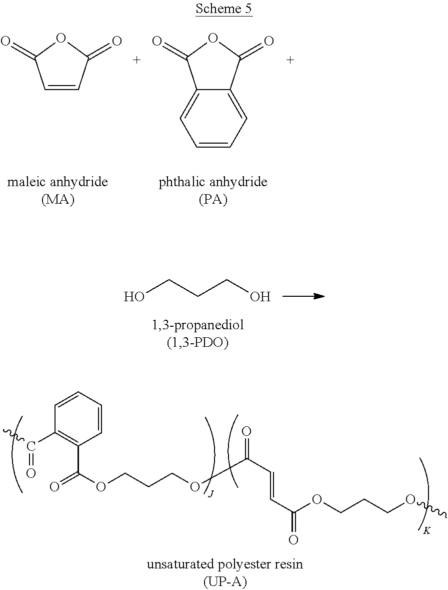

where the J and K are independently any integer between 1 and about 25.

### Comparative Example B

An unsaturated polyester (UP-B) was synthesized in a 5 L, 4-neck round bottom flask equipped with a heating mantle, overhead mechanical stirrer, nitrogen sparge, Schnyder column distillation apparatus (with a 500 mL round bottom receiving flask), and an overhead thermometer. The flask was filled with nitrogen gas from the sparge prior to the addition of, in this specific order, 1,3-PDO (668.83 g), 1,2-PG (167.39 g), PA (740.05 g), HQ (0.2066 g), and MA (490.40 g). The temperature of the mixture was first raised to 120° C. at a rate of 2° C./min and held for 2 h with water being continually distilled off. The temperature of the mixture was then raised to 215° C. at a rate of 6° C./min with continued water distillation. Reaction progress during heating at 215° C. was followed by determining the acid number (AN, see General Methods) and Gardner Holdt viscosity level (see General Methods) of the mixture at regular intervals (every 1.5 to 2 h). The reaction was discontinued when the AN reached a level of 11 and the Gardner Holdt viscosity reached a level of S²-T (518-547 cSt). The reaction temperature was then lowered from 215° C. to 145° C. by blowing air from a plastic hose over the resulting UP-B mixture while stirring. The total mass of the mixture after completion was 2026.4 g. The reactants and a portion of a resulting copolymer product are shown in Scheme 6.

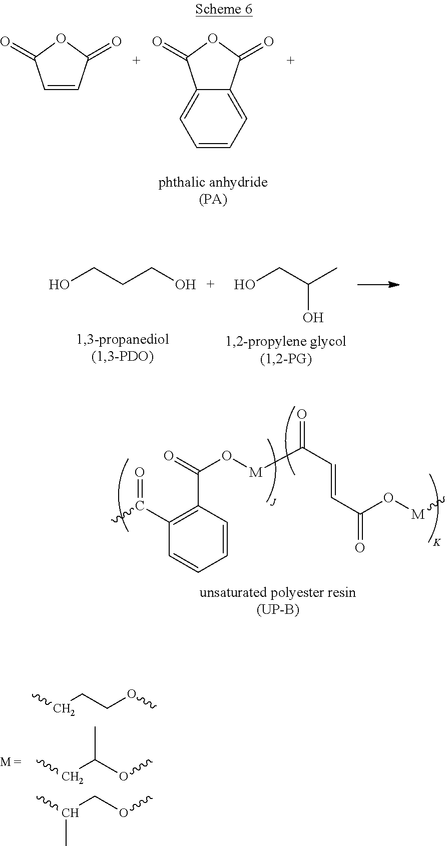

where the J and K are independently any integer between 1 and about 25.

### Example C

### Generating a Curable Composition by 1,3-PDO-DA Addition

An aliquot of the UP-A product generated in Example A (60.1 g) was placed in a round bottom flask and stirred at 145° C. An aliquot of 1,3-PDO-DA (40.3 g) was then added to this UP-A aliquot with stirring. The mixture was then cooled to 120° C. and stirred until a homogeneous solution was obtained. The resulting curable composition was then cooled to room temperature and used in the casting of the plaque described in Example E.

### Example D

### Generating a Curable Composition by Styrene Addition

An aliquot of the UP-B product generated in Example B (1917.2 g) was placed in a round bottom flask and stirred at 140° C. An aliquot of styrene (1278.2 g) with the inhibitor toluhydroquinone (0.0639 g, 50 ppm) was then added to this UP-B aliquot and stirred until a homogeneous solution was obtained. The resulting curable composition was then cooled to room temperature and used in the casting of the plaque described in Example F.

### Example E

### Casting a Plaque of the Composition of Example C

An aliquot of the curable composition prepared in Example C (100.4 g) was mixed in a 1 L beaker with 0.030 g of a cobalt(II) 2-ethylhexanoate solution (0.0195 g of cobalt (II) 2-ethylhexanoate and 0.0105 g of mineral spirits) until homogeneity was reached. Then a mixture of 1.2 g of Luperox® 26 and 1.2 g of 1,3-PDO-DA was stirred into the curable composition mixture until homogeneity was reached. This solution was then placed into a vacuum oven set to room temperature with active vacuum for 20 min. The solution was then slowly poured from the beaker into a mold prepared as described in General Methods through the opening of the U-shaped gasket, formed by the latex tubing in the assembled mold, to mitigate the formation of air bubbles. The mold was then placed in a convection oven set to 40° C. for 1 h. The temperature was then raised to 54° C. for 3 h. After this initial curing cycle, the binder clips, Teflon® spacers, and latex hose were removed from the mold. The resulting plaque and remaining mold configuration were then placed in a convection oven set to 82° C. for 2 h. The plaque and remaining mold configuration were then placed in a water bath to cool. The resulting plaque contains UP-A with crosslinks in the maleic-anhydride portion of the copolymer chain as shown in Scheme 2.

### Example F

### Casting a Plaque of the Composition of Example D

An aliquot of the curable composition prepared in Example D (275.3 g) was mixed in a 1 L beaker with 2.77 g of benzoyl peroxide until homogeneity was reached. The solution was then slowly poured from the beaker into a mold prepared as described in General Methods through the opening of the U-shaped gasket, formed by the latex tubing in the assembled mold, to mitigate the formation of air bubbles. The mold was then placed in a convection oven set to 54° C. for 4 h. After this initial curing cycle, the binder clips, Teflon® spacers, and latex hose were removed from the mold. The formed plaque and remaining mold configuration were then placed in a convection oven set to 82° C. for 2 h, after which the temperature was raised to 121° C. for 1 h. The oven was then turned off and the plaque and remaining mold configuration were cooled to room temperature in air. The resulting plaque contains UP-B with crosslinks as shown in Scheme 7.

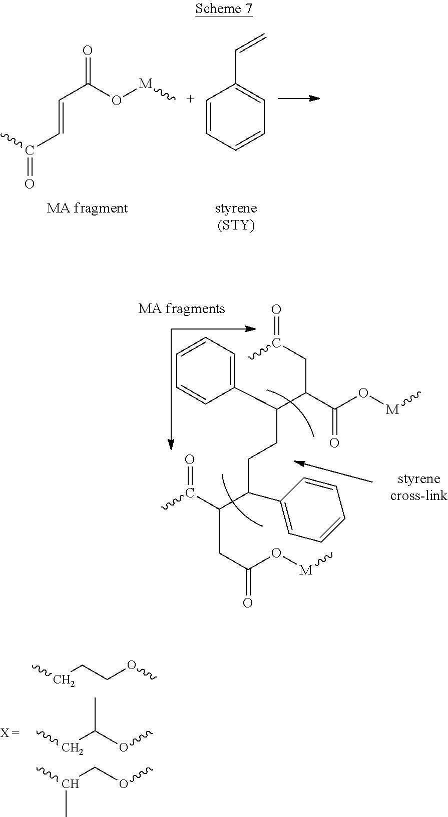

### Example 8

### Elemental Analysis

Electron Spectroscopy for Chemical Analysis (ESCA) was performed on the plaques prepared in Examples 5-7, E and F using either a PHI 5800ci spectrometer or an Ulvac-PHI Quantera spectrometer. PHI MultiPak software was used for data analysis. Plaques from comparative examples E and F, containing crosslinked copolymer made without F16-IPA, did not exhibit any signal for fluorine atoms in their ESCA spectra. Plaques from examples 5, 6, and 7, which each contained crosslinked copolymer made with F16-IPA, exhibited signals for fluorine atoms in their ESCA spectra. The theoretical ratios of fluorine and carbon atoms in the plaques (F/C ratios) from examples 5, 6, and 7 were 0.023, 0.023, and 0.021, respectively. The F/C ratios were determined separately for the side of the plaque that had been in contact with glass in the mold, and for the side of the plaque that had been in contact with the Duralam® Gold Fabric possessing a poly(tetrafluoro ethylene) surface (Teflon®), after cleaning, and are given in Table 3 below.

### Example 9

### Water Contact Angles on Plaques

Advancing and receding water contact angle measurements were determined on the plaques prepared in Examples above using a Rame'-Hart Model 100-25-A goniometer (Rame'-Hart Instrument Co.). The built in DROPimage Advanced v2.3 software system was used to analyze the data. Contact angle analysis was performed by depositing a 4 μL aliquot of the test liquid onto the surface of the prepared plaque using a micro syringe dispensing system. Contact angles were measured on the side of the plaque that had been in contact with glass in the mold, and for the side of the plaque that had been in contact with the Duralam® Gold Fabric possessing a poly(tetrafluoro ethylene) surface (Teflon®), both prior to and after cleaning as described in General Methods, and are given in Table 3 below. Also measurements for the right and left sides of the test liquid droplet are given. Water contact angle values for plaques made in comparative examples E and F, containing crosslinked copolymer made without F16-IPA, were apolar and water repellent. Water contact angle values for plaques made in Examples 5, 6, and 7, containing crosslinked copolymer made with F16-IPA, were higher than those for plaques of comparative examples E and F.

### Example 10

### Hexadecane Contact Angles on Plaques

Advancing and receding hexadecane contact angle measurements were determined on the prepared plaques (vide supra) following the same techniques used to measure water contact angles as in Example 9. Plaques of comparative Examples E and F, containing crosslinked copolymer made without F16-IPA, showed no hexadecane contact angles, and were oleophilic. For plaques made in Examples 5, 6, and 7, containing crosslinked copolymer made with F16-IPA, the hexadecane contact angles are presented in Table 3 below and were ˜50° for all samples.

### Example 11

### Clarity of Plaques

The prepared plaques were examined for clarity by visual inspection. Plaques prepared in comparative Examples E and F, containing crosslinked copolymer made without F16-IPA, qualitatively exhibited haziness and opacity (Table 3). Plaques prepared in Examples 5, 6, and 7, containing crosslinked copolymer made with F16-IPA, were all optically clear (Table 3).

TABLE 3
Properties for plaques of Examples 5-7 and E-F; contact angles
measured on left (L) and right ® sides of the drop

| | Example number of sample | | | | |
|---|---|---|---|---|---|
| Analysis | E | F | 5 | 6 | 7 |
| Elemental Analysis | | | | | |
| Calculated F/C ratio | 0 | 0 | 0.023 | 0.023 | 0.021 |
| F/C ratio by ESCA [glass] | 0 | 0 | 0.19 | 0.26 | 0.21 |
| F/C ratio by ESCA [Teflon] | 0 | 0 | 0.24 | 0.34 | 0.33 |
| Water Contact Angles | | | | | |
| Uncleaned-glass side - L | 76.55 | 91.33 | 93.67 | 104.73 | 93.66 |
| Uncleaned-glass side - R | 76.32 | 90.66 | 91.99 | 104.34 | 94.54 |
| Uncleaned-Duralam ® side - L | 75.13 | nT^{c} | 97.07 | marred^{d} | 97.06 |
| Uncleaned-Duralam ® side - R | 75.03 | nT^{c} | 96.42 | marred^{d} | 96.89 |
| Cleaned-side^{a} - L | 75.04 | 90.40 | 90.85 | 95.54 | 89.40 |
| Cleaned-side^{a} - R | 73.82 | 88.94 | 89.21 | 94.54 | 89.11 |
| Cleaned-side^{a} - L | 75.04 | nT^{c} | 96.21 | marred^{d} | 97.27 |
| Cleaned-side^{a} - R | 73.82 | nT^{c} | 96.81 | marred^{d} | 97.37 |
| Hexadecane Contact Angles | | | | | |
| Uncleaned-glass side - L | nm^{b} | nm^{b} | 47.44 | 52.75 | 17.15 |
| Uncleaned-glass side - R | nm^{b} | nm^{b} | 48.13 | 52.49 | 17.5 |
| Uncleaned-Duralam ® side - L | nm^{b} | nm^{b} | 47.5 | nd^{d} | 47.29 |
| Uncleaned-Duralam ® side - R | nm^{b} | nm^{b} | 48.3 | nd^{d} | 47.39 |
| Cleaned-glass side - L | nm^{b} | nm^{b} | 38.45 | 43.43 | 21.71 |
| Cleaned-glass side - R | nm^{b} | nm^{b} | 38.32 | 42.47 | 22.33 |
| Cleaned-Duralam ® side - L | nm^{b} | nm^{b} | 46.48 | nd^{d} | 46.71 |
| Cleaned-Duralam ® side - R | nm^{b} | nm^{b} | 47.03 | nd^{d} | 46.44 |
| Plaque optical properties | | | | | |
| Color | green | green | green | green | green |
| Clarity | hazy | opaque | clear | clear | clear |

^{a}Sample was not marked. Unknown if glass or Duralam ® side was measured.
nm^{b} No measurements could be obtained because the droplets were too flat to record an angle.
nT^{c} No data is available, because no Duralam ® sheet was used during cure.
nd^{d} Plaque surface was marred and rough, preventing angle measurement

1. A copolymer comprising a first repeat unit having a backbone and a second repeat unit, wherein said first repeat unit comprises olefinic unsaturation in the backbone thereof, and said second repeat unit is a fluorovinylether functionalized aromatic repeat unit represented by the structure (I) 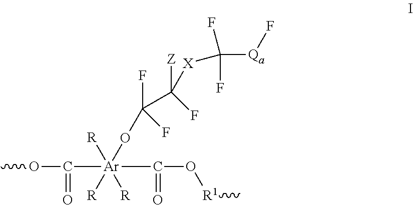
wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II) 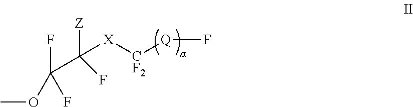
with the proviso that only one R can be OH or the radical represented by the structure (II);
R1 is a C2-C4 alkylene radical which can be branched or unbranched,
X is O or CF₂;
Z is H, Cl, or Br;
a=0 or 1;
and,
Q represents the structure (Ia) 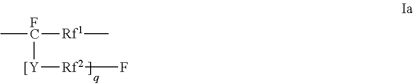
wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

2. The copolymer of claim 1 where Ar is a benzene radical.

3. The copolymer of claim 1 wherein each R is H.

4. The copolymer of claim 1 wherein R¹ is an ethylene radical, a trimethylene radical which can be branched, or a tetramethylene radical which can be branched.

5. The copolymer of claim 1 wherein said first repeat unit is represented by structure (V) 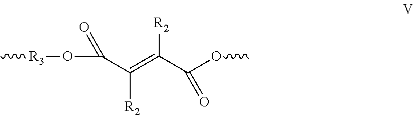
wherein R₂ is independently H or C₁-C₁₀ alkyl;
and R₃ is a C₂-C₄ alkylene radical.

6. The copolymer of claim 5 wherein each R₂ is H and R₃ is a trimethylene radical.

7. The copolymer of claim 1 further comprising third repeat units represented by Structure VI 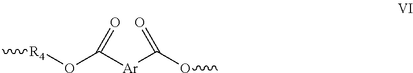
wherein R₄ is a C₂-C₄ alkylene radical, and Ar is an aromatic diradical.

8. The copolymer of claim 7 wherein R₄ is a trimethylene radical and Ar is a benzene radical.

9. A process comprising combining a fluorovinylether functionalized aromatic diester or diacid, an olefinically unsaturated mono-anhydride, and at least one C₂-C₄ alkylene glycol, branched or unbranched, to form a reaction mixture, and stirring the reaction mixture to form a copolymer comprising repeat units having the structure (I) 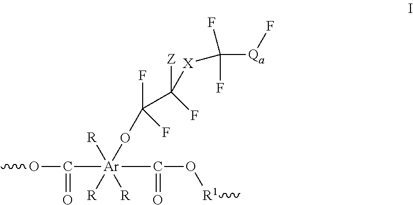
wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II) 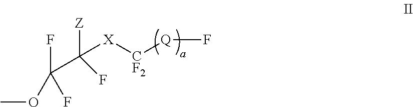
with the proviso that only one R can be OH or the radical represented by the structure (II);
R1 is a C2-C4 alkylene radical which can be branched or unbranched,
X is O or CF₂;
Z is H, Cl, or Br;
a=0 or 1;
and,
Q represents the structure (Ia) 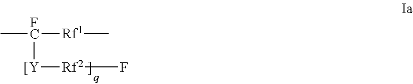
wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.
and repeat units having the structure (V) 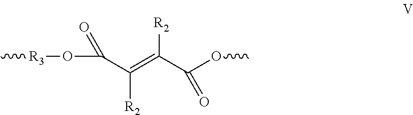
wherein R₂ is independently H or C₁-C₁₀ alkyl;
and R₃ is a C₂-C₄ alkylene radical;
wherein the fluorovinyl ether functionalized aromatic diester or diacid is represented by the structure (III) 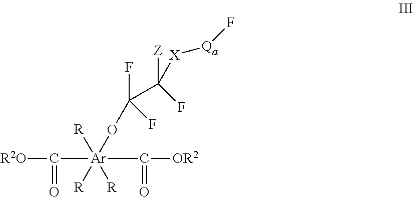
wherein,
Ar represents a benzene or naphthalene radical;
each R is independently H, C₁-C₁₀ alkyl, C₅-C₁₅ aryl, C₆-C₂₀ arylalkyl; OH, or a radical represented by the structure (II) 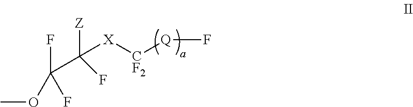
with the proviso that only one R can be OH or the radical represented by the structure (II);
R² is H or C₁-C₁₀ alkyl;
X is O or CF₂;
Z is H, Cl, or Br;
a=0 or 1;
and,
Q represents the structure (Ia) 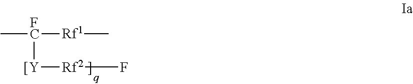
wherein q=0-10;
Y is O or CF₂;
Rf¹ is (CF₂)ₙ, wherein n is 0-10;
and,
Rf² is (CF₂)ₚ, wherein p is 0-10, with the proviso that when p is 0, Y is CF₂.

10. The process of claim 9 wherein Ar is a benzene radical.

11. The process of claim 9 wherein each R is H.

12. The process of claim 9 wherein the olefinically unsaturated mono-anhydride is represented by the structure (VIII) 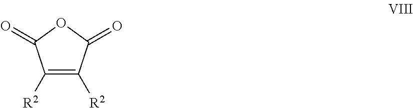
wherein each R² is independently H or C₁-C₁₀ alkyl.

13. The process of claim 12 wherein each R² is H.

14. The process of claim 9 wherein the C₂-C₄ alkylene glycol is selected from the group consisting of 1,2-ethanediol, 1,2-propylene glycol, 1,3-propanediol, 1,2-butanediol, 1,3-butanediol, 1,4-butanediol, and mixtures of two or more thereof.

15. The process of claim 9 further comprising combining in the reaction mixture an aromatic anhydride represented by the structure (IX) 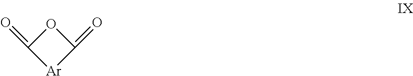
wherein Ar is an aromatic radical.

16. The process of claim 14 wherein Ar is a benzene radical.

17. The process of claim 9 wherein the reaction mixture further comprises an inhibitor that retards polymerization.

18. A fiber, fabric, carpet, film, plaque, or shaped article comprising the copolymer of claim 1.

19. A resin composition comprising the copolymer of claim 1.

20. fiber, fabric, carpet, film, plaque, or shaped article impregnated or coated with a resin comprising the copolymer of claim 1.
